(19) United States
(12) Patent Application Publication
(10) Pub. No.: US 2025/0039931 A1
(43) Pub. Date: Jan. 30, 2025

(54) SYSTEM AND METHOD FOR COLLISION-FREE JOINING OF WIRELESS INPUT/OUTPUT (IO) DEVICES TO A WIRELESS IO DEVICE NETWORK

(71) Applicant: Dell Products, LP, Round Rock, TX (US)

(72) Inventors: Kai Leong Wong, Singapore (SG); Jui Chang Liu, New Taipei City (TW); Karthikeyan Krishnakumar, Austin, TX (US)

(73) Assignee: Dell Products, LP, Round Rock, TX (US)

(21) Appl. No.: 18/227,963

(22) Filed: Jul. 30, 2023

(51) Int. Cl. H04W 74/08; H04W 28/26; H04W 72/0446

(52) U.S. Cl. CPC H04W 74/0816; H04W 28/26; H04W 72/0446

(57) ABSTRACT

A collision free wireless input/output (IO) device network joining system of a wireless communication dongle at an information handling system may comprise a wireless radio system to transmit an initial polling packet to instruct transmission by a first wireless IO device of data at allotted time slots and to allot additional time for a reserved provisional time slot, the wireless radio system to receive, during a first communication frame, data at the allotted time slots from the first wireless IO device and the connection request at the reserved provisional time slot from the second wireless IO device, and the wireless radio system to transmit an updated polling packet instructing transmission, during a second communication frame, data from the first wireless IO device during first allotted time slots and of data from the second wireless IO device during second allotted time slots.

### FIELD OF THE DISCLOSURE

The present disclosure generally relates to wireless peripheral input/output (IO) devices, such as mice, keyboards, earbuds, headphones, headsets, and virtual reality peripherals. More specifically, the present disclosure relates to a wireless communication from an information handling system, operating independently from the information handling system operating system (OS) for orchestrating a data packet collision-free method of allowing an additional wireless peripheral input/output (IO) device to join a network that already includes at least one wireless peripheral IO device in wireless communication with a wireless radio system of the information handling system or a wireless communication dongle operatively connected to the information handling system.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, video communication capabilities, and audio capabilities. The information handling system may be operatively coupled to one or more peripheral input/output devices such as a keyboard, mouse, touchpad, display device, wearable peripheral device, speakers, earbud, headphone, microphone, or other peripheral devices.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system with a wireless radio system or an operatively coupled wireless communication dongle orchestrating wireless communication with plural wireless input/output (IO) devices according to an embodiment of the present disclosure;

FIG. 2 is a block diagram illustrating a wireless IO device wirelessly paired to a wireless radio adapter or a wireless communication dongle that is operatively coupled to an information handling system according to an embodiment of the present disclosure;

FIG. 3 is a block diagram illustrating a data packet communication frame with joining second wireless IO device orchestrated by the collision free wireless IO device network joining system according to an embodiment of the present disclosure;

FIG. 4 is a block diagram illustrating a data packet communication frame between a wireless communication dongle and a plurality of operatively connected wireless IO devices according to an embodiment of the present disclosure;

FIG. 5 is a flow diagram illustrating a method of orchestrating collision-free joinder of a second wireless IO device to a network in a data packet communication frame that includes a first wireless IO device and a wireless communication dongle according to an embodiment of the present disclosure; and

FIG. 6 is a flow diagram illustrating a method of orchestrating transmission of data packets in a data packet communication frame switching to add one or more wireless IO devices for communication with a wireless radio adapter or wireless communication dongle according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Users of information handling systems such as smart phones, tablets, or laptops may employ a plurality of wireless peripheral input/output (IO) devices, also referred to as wireless IO devices herein, (e.g., mouse, keyboard, earbuds, headphones, smart speakers, headsets including headphones and speakers, or virtual reality peripherals) located remotely from the information handling system to wirelessly transmit and receive IO data such as keystrokes, mouse positional data, or audiovisual information. Many existing systems employ a wireless communications dongle operably connected to the information handling system (e.g., desktop, laptop, or tablet computer) to pair with and communicate wirelessly with one or more of these wireless IO devices. In other embodiments, a wireless communication dongle may be integrated as part of the wireless radio adapter internal to the information handling system for pairing with and communicating wirelessly with one or more of these wireless IO devices. Many manufacturers of these wireless IO devices build these devices to provide the most basic or rudimentary communication capabilities that comply with the Bluetooth® Low Energy (BLE) communication standard.

For example, many existing wireless IO devices are designed to communicate with a wireless communications dongle using a one reception/one transmission (1RX/1TX) format that requires a wireless communications dongle to respond to every data packet received from a wireless IO device by transmitting an acknowledgment (ACK) data packet. In other words, each time the wireless communications dongle operating in receive mode receives a data packet, it must then switch to transmit mode and transmit an ACK data packet back to the wireless IO device from which the initial data packet was received. The wireless communications dongle may then switch back to a receive mode to receive the next data packet from the wireless IO device. This process may be repeated each time a new data packet is generated at the wireless IO device, for example. More specifically, in the case of a wireless mouse, this process may be repeated each time the wireless mouse determines the location of the mouse has changed, prompting a correlated change in the position of a cursor within a display device for the information handling system. Thus, this mode-switching may occur multiple times per second in some cases.

Each of these transmission/reception mode switches consumes power, requires more airtime for acknowledgments, limiting performance of a wireless IO device by speed or volume of incoming wireless IO device data packets and outgoing ACK data packets. In some cases of a collision or poor wireless speed, the wireless communications dongle may fail to transmit an ACK data packet (as no data packet has been received by the dongle from the wireless IO device due to the collision), and the wireless IO device may then either resend the missed data packet or skip this resend and simply transmit the next available data packet. Such a 1RX/1TX system may be limited in data throughput and consume power unnecessarily for such transmit and receive switches during operations. Such systems may cause the customer to experience slow response from a wireless IO device, a lag between their input via the wireless IO device (e.g., movement of the mouse) and the corresponding feedback displayed by the information handling system (e.g., movement of the cursor), or may cause the cursor to jump suddenly from one position to another (e.g., when the wireless mouse opts to skip resend of the missed packet). As a result, existing systems employing this 1RX/1TX approach may fail to meet customer needs during execution of latency-sensitive or report rate sensitive software applications such as gaming applications or other high definition audio/visual applications.

Wireless dongle transmission and reception of data packets using this 1RX/1TX communication with a plurality of wireless IO devices further increases the risk of poor performance of the plurality of IO devices. For example, the wireless communication dongle in such a scenario may need to transmit ACK data packets to both paired wireless IO devices, presenting more potential delay and use of airtime for acknowledgements while switching between plural paired wireless IO devices. In other words, communication with a plurality of wireless IO devices may cause an even more limited data throughput level or greater number of missed or dropped data packets, causing even greater customer-perceived latency or poor user experience.

A controller for the wireless communications dongle or internal wireless radio system of an information handling system executing code instructions of the collision free wireless IO device network joining system in embodiments of the present disclosure addresses these issues by orchestrating scheduled delivery of a plurality of data packets from each of one or more wireless IO devices in a data packet communication frame between delivery of ACK data packets as part of a polling packet to each of those one or more wireless IO devices in a wireless device communication protocol. In embodiments of the present disclosure, the wireless communications dongle or internal wireless radio system of an information handling system may engage in communication of data packets with a plurality of wireless IO devices (e.g., a headset, or keyboard, and a mouse). In some cases, one of these wireless IO devices may have entered a sleep mode due to lack of use. In such a scenario, the wireless communications dongle or internal wireless radio system of an information handling system may orchestrate delivery of data packets from a first wireless IO device (e.g., mouse) alone while a second wireless IO device (e.g., keyboard) remains in a low-power or sleep state to conserve power.

The second wireless IO device (e.g., keyboard) that is not currently transmitting data to the wireless communications dongle or internal wireless radio system of the information handling system may wake from a low power or sleep state and be ready for radio communications. Upon waking, the second wireless IO device (e.g., keyboard) in embodiments of the present disclosure may need to transmit a new connection request to the wireless communications dongle or internal wireless radio system of an information handling system in order to begin transmitting data packets during an upcoming data packet communication frame. In existing systems, the second wireless IO device may immediately use its radio and transmit the new connection request, sometimes repeatedly, until it receives a response from the wireless communications dongle or internal wireless radio system of an information handling system. However, this may be an issue with ongoing data packet communication frames delivered to the wireless dongle from the first wireless IO device between polling packets. The present disclosure describes a wireless communication protocol embodiment with data packet communication frames using a provisional packet time slot in the frame to allow the wireless dongle to switch from a single wireless IO device mode to a plural IO device mode. Because the controller for the wireless communications dongle or internal wireless radio system of an information handling system in embodiments of the present disclosure orchestrates delivery of data packets from the first wireless IO device during time slots currently assigned to the first wireless IO device, transmission of the new connection request by the second wireless IO device during these time slots currently assigned to the first wireless IO device may pose an increased risk of collision and lack of receipt at the wireless communications dongle or internal wireless radio system of an information handling system, since there is no slot for the second wireless IO device to transmit a connection request to join the wireless communication dongle. A system is needed to orchestrate delivery of new connection requests by the second wireless IO device upon waking that does not pose an increased risk of collision with incoming data packets from the first wireless IO device during time slots currently assigned to the first wireless IO device with an abbreviated provisional time slot added to the data packet communication frames.

In embodiments of the present disclosure, a wireless radio adapter, such as in a wireless communications dongle, may initiate each of several consecutive data packet communication frames with operatively coupled wireless IO devices (e.g., the first wireless IO device or mouse) by transmitting an initial polling packet. A controller of the wireless radio adapter executing code instructions of the collision free wireless IO device network joining system may generate such an initial polling packet in embodiments of the present disclosure to instruct the first wireless IO device paired with the wireless communications dongle to transmit a plurality of data packets of a specified length and at specified time slots during a first data packet communication frame between the wireless communications dongle and the paired first wireless IO devices. The initial polling packet preceding each such data packet communication frame with the first wireless IO device in embodiments may further include a reserved provisional time slot within the upcoming data packet communication frame in which other wireless IO devices that are not operatively connected to the wireless communications dongle or internal wireless radio system of the information handling system may transmit a new request to connect to the wireless communications dongle or internal wireless radio system of the information handling system. Such a reserved provisional time slot may be abbreviated in duration to fit a short request to connect while not causing significant delay and frame latency. In one example embodiment, an extended time duration of the data packet communication frame may be less than 200 microseconds for the abbreviated reserved provisional time slot. In another example embodiment, an extended time duration of the data packet communication frame may be 100 microseconds or less for the abbreviated reserved provisional time slot. In other embodiments, the additional timespan in the data packet communication frame for the reserved provisional time slot may not occur during every frame, but may operate on a duty cycle. For better performance and reduced latency, the reserved provisional timeslot may occur for the extended span of time during a designated data packet communication frame that is cycled among a plurality of data packet communication frames in some embodiments. For example, the added time for the reserved, provisional time slot may occur every fourth data packet communication frame (e.g., every 2 ms) in one embodiment. A second wireless IO device seeking to join will await the next designated data packet communication frame having a reserved provisional time slot. The frame with the reserved provisional timeslot may be identified via a header or instruction in the polling packet preceding the designated data packet communication frame in example embodiments.

The controller may ensure that, during the upcoming data packet communication frame in which time slots have been allocated to the first wireless IO device (e.g., mouse), the wireless radio system, such as in the wireless communication dongle, remains in a receive mode to receive data packets from the first wireless IO device in accordance with the number of packets prescribed and the duration (e.g., based on packet lengths) from the first wireless IO device. Several of such data packet communication frames may take place in such a manner between the first wireless IO device and the wireless radio system of the wireless communications dongle or information handling system. The wireless dongle may stay in receive mode for an additional, abbreviated duration at the end of the frames to allow for the reserved provisional time slot.

The second wireless IO device may turn its radio on and place the radio in a receive (RX) mode to listen for polling packets transmitted by the wireless communications dongle or internal wireless radio system of the information handling system. The second wireless IO device in embodiments may then receive the initial polling packet, described directly above, that instructs the first wireless IO device to transmit a plurality of data packets at specified time slots during a first data packet communication frame and including the reserved provisional time slot within the upcoming data packet communication frame at which the second wireless IO device may transmit a new request to connect. The second wireless IO device may continue monitoring the packets from the first wireless IO device in RX mode or use a timer based queue control to determine when all packets are sent in the frame having the reserved, provisional time slot. A timer based queue control may allow the second wireless IO device to receive indication of the initial polling packet for the data packet communication frame having a reserved provisional time slot and determine the number of data packets and length expected from the first wireless IO device in one example embodiment. Upon determining the first data packet from the first wireless IO device is transmitted, the second wireless IO device may then turn off its radio until the last data packets from the first wireless IO device are scheduled to be sent in some embodiments. The second wireless IO device in either embodiment of the present disclosure for continuous monitoring or time based queue control may switch its radio to a transmit (TX) mode and transmit a new request to connect to the wireless communications dongle or internal wireless radio system of the information handling system during the additional, abbreviated duration for the reserved provisional time slot within the upcoming data packet communication frame. The request to connect will include a number of packets and packet length needed in an embodiment. The wireless radio adapter, such as in a wireless communications dongle, may receive this request to connect from the second wireless IO device (e.g., keyboard), and then may respond to the request to connect by transmitting a second, updated polling packet that instructs each of the wireless IO devices paired with the wireless communications dongle that have requested to connect (e.g., both mouse and keyboard) to transmit a plurality of data packets of a specified length and at specified time slots during a second data packet communication frame between the wireless communications dongle and each of the paired first and second wireless IO devices.

Following the second data packet communication frame, at the end of a time period determined by the number of packets expected, packet lengths, and any additional time for a reserved provisional time slot, the controller of the wireless communications dongle or other wireless radio adapter may switch to transmit mode and transmit to each of the paired first and second wireless IO devices (e.g., mouse and keyboard) an acknowledgement identifying the number of packets received during the second data packet communication frame from each of the paired wireless IO devices in the next polling packet. In addition, this next polling packet may further include instructions for the one or more paired wireless IO devices to transmit the specified plural number of data packets of a specified length and at specified time slots during a second data packet communication frame between the wireless communications dongle and each of the paired wireless IO devices. In such a way, the collision free wireless IO device network joining system may orchestrate a collision-free method for a second wireless IO device to join a network in which the wireless communications dongle or internal wireless radio system of the information handling system is currently operatively connected to a first wireless IO device and using data communication frames under the wireless IO device protocol of the present embodiments. This may decrease the frequency of ACK data packets transmitted, latency, and the frequency of mode-switching described herein with respect to existing systems, improve overall user experience, and may further decrease power consumed by rapid mode-switching.

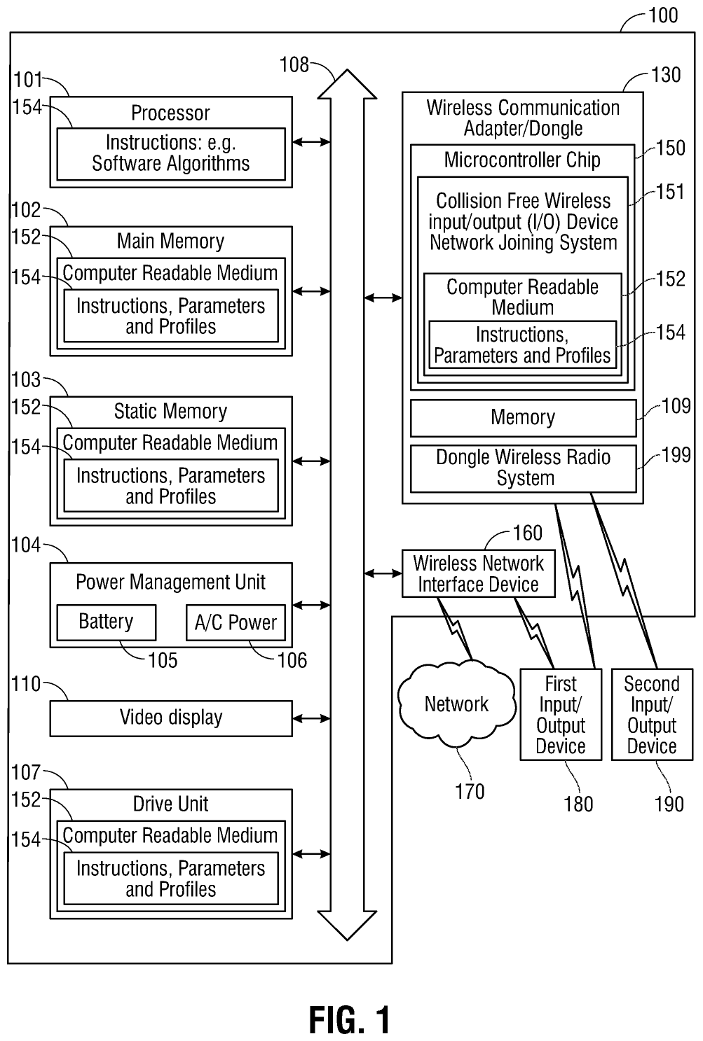

FIG. 1 illustrates an information handling system 100 according to several aspects of the present disclosure. As described herein, an information handling system 100 or a controller 150 of a wireless communications dongle or integrated wireless radio adapter 130 operably connected to the information handling system 100 may execute code instructions of a collision free wireless input/output (IO) device network joining system 151 for wireless IO device communication protocol in an embodiment to synchronize wireless device IO joining method for one or more paired wireless input/output (IO) devices (e.g., 180 and 190) and a wireless communications dongle or integrated wireless radio adapter 130 of an information handling system 100 conducting ongoing wireless data packet communications under the wireless IO device communication protocol of embodiments herein. It is appreciated that information handling system 100 may use a wireless communications dongle or integrated wireless radio adapter 130 to wirelessly communicate with one or more wireless IO devices 180 or 190. In embodiments herein, wireless communications dongle 130 may refer to a dongle operatively coupled to the information handling system 100 such as via a port or may be integrated within the information handling system 100 such as with an integrated wireless radio adapter with antenna system for wireless communication with the wireless IO devices 180 or 190 under the wireless IO device communication protocol described in embodiments herein. In various embodiments a wireless communications dongle 130, whether integrated or not within the information handling system 100 may operate using the Bluetooth® Low Energy (BLE) radio layer protocol data modulation (using Gaussian Frequency Shift Keying (GFSK) data modulation) with additional modification to the communication protocol described in embodiments herein. An information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or multiple sets, of instructions to perform one or more computer functions.

In a networked deployment, the information handling system 100 may operate in the capacity of a server or as a client computer in a server-client network environment, or as a peer computer system in a peer-to-peer (or distributed) network environment. In a particular embodiment, the information handling system 100 may be implemented using electronic devices that provide voice, video or data communication. The information handling system 100 may include a memory 102, (with computer readable medium 152 that is volatile (e.g. random-access memory, etc.), nonvolatile memory (read-only memory, flash memory etc.) or any combination thereof), one or more hardware processing resources including hardware processor 101, such as a central processing unit (CPU), a graphics processing unit (GPU), a Visual Processing Unit (VPU) or a Hardware Accelerator, any one of which may be the hardware processor 101 illustrated in FIG. 1, a hardware controller, an embedded controller (EC), or any combination thereof. Additional components of the information handling system 100 may include one or more storage devices such as static drive 103 or drive unit 107, a wireless network interface device 160, and one or more communications ports for communicating with external devices such as wireless communication adapter/dongle 130 (referred to herein as a wireless communications dongle). A power management unit (PMU) 104 supplying power to the information handling system 100, via a battery 105 or an alternating current (A/C) power adapter 106 may supply power to one or more components of the information handling system 100, including the hardware processor 101, the wireless network interface device 160, a static memory 103 or drive unit 107, the wireless communication adapter/dongle 130, a video display 110, or other components of an information handling system. The video display 110 in an embodiment may function as a liquid crystal display (LCD), an organic light emitting diode (OLED), a flat panel display, or a solid-state display. The information handling system 100 may also include one or more buses (e.g., 108) operable to transmit communications between the various hardware components.

The information handling system 100 in an embodiment is operably coupled to a wireless communications dongle 130, which may orchestrate scheduled delivery of a plurality of data packets from each of a plurality of wireless input/output (IO) devices (e.g., 180 and 190) during scheduled data packet communication frames according to various embodiments of the present disclosure. The wireless communication dongle 130 or integrated wireless radio adapter in an embodiment may house a microcontroller 150 executing firmware instructions of the collision free wireless IO device network joining system 151 of the wireless IO device communication protocol in an embodiment. The wireless communication dongle 130 may be operatively coupled to the information handling system 100 through insertion of the wireless communication dongle 130 within a Universal Serial Bus (USB) port of the information handling system 100 in an embodiment, for example. In another embodiment, the wireless communication dongle 130 may be incorporated within the housing of the information handling system 100 as part of an integrated wireless radio adapter and operatively coupled to the bus 108 of the information handling system 100 through one of several means for transmitting data, including connection through a USB hub, a Thunderbolt hub, or any other type of data transfer hub known in the art.

The wireless communication dongle 130 in an embodiment may be wirelessly coupled to one or more wireless input output (IO) devices 180 and 190 capable of wirelessly receiving and transmitting data via BLE radio layer protocol (e.g., a BLE radio using GFSK data modulation) with the wireless communication adapter/dongle 130 as modified by the wireless IO device communication protocol described in embodiments herein. In some embodiments, the wireless IO devices 180 or 190 may comprise a mouse, keyboard, speaker, headphones, earbuds, headset including a microphone, or various virtual reality peripherals including a headset or handheld input devices. Information handling system 100 may be any information handling system, such as a smart phone, tablet, or laptop, used with a wireless IO device 180 or 190.

The wireless communication dongle wireless radio system 199 or other integrated wireless radio adapter in an embodiment may be capable of communication between the information handling system 100 and the paired wireless IO devices 180 and 190 using a wireless link established using BLE radio layer protocol with GFSK data modulation, as modified by the wireless IO device communication protocol of embodiments herein, for example. The wireless communication dongle wireless radio system 199 or other integrated wireless radio adapter in an embodiment may transmit and receive information necessary to pair the wireless IO devices 180 and 190 with the information handling system 100, such as, for example, pairing or wireless communication profiles for pairing the information handling system 100 and the wireless IO devices 180 and 190. Such pairing or wireless communication profiles may operate to identify the wireless IO devices 180 and 190 as a device authorized to transceive data with the information handling system 100 under the paired wireless protocol, as well as information sufficient to identify the wireless IO devices 180 and 190, such as a Media Access Control (MAC) address, IP address, or model number. The pairing or wireless communication profiles may further include an assigned radio frequency or channel upon which the wireless IO device (e.g., 180 or 190) is instructed to transmit requests to connect to the wireless communications dongle 130 upon switching from a sleep mode to a waking state pursuant to execution of code instructions of the collision free wireless IO device network joining system 151 with the wireless IO device communication protocol using data communication frames and polling packets of embodiments herein.

The wireless communication dongle wireless radio system 199 may provide connectivity of the wireless communication dongle 130 operatively coupled to the information handling system 100 via wireless links to one or more operatively coupled wireless input/output devices 180 or 190, such as mouse, keyboard, earbuds, headphones, smart speakers, or virtual reality peripherals, as described in greater detail herein. Such wireless links may be established pursuant to BLE radio layer protocol with GFSK data modulation, as modified by the wireless IO device communication protocol of embodiments herein, for example. In some embodiments, the BLE radio layer protocol with GFSK data modulation, as modified by the wireless IO device communication protocol of embodiments herein may be used to establish a Private Area Network (PAN) (e.g., 170) in which the information handling system 100 may communicate wirelessly with any wireless IO devices (e.g., 180 and 190) paired to the PAN 170 using a BLE radio layer protocol with GFSK data modulation compliant pairing and wireless communication profile with the wireless IO device communication protocol of embodiments herein. The PAN 170 in such an embodiment may communicate data between the information handling system 100 and any paired wireless IO devices (e.g., 180 and 190) over short distances using Ultra High Frequency (UHF) radio waves in the Industrial, Scientific, and Medical purposes bands (ISM bands) between 2.402 and 2.48 GHz. Reference to Bluetooth® may refer to either or both of the Bluetooth® or Bluetooth Low Energy (BLE) and any revision of those portions of the protocols as modified with the wireless IO device communication protocol of embodiments herein.

In some aspects of the present disclosure, the wireless communication dongle wireless radio system 199 may operate two or more wireless links. In other aspects of the present disclosure, the wireless communication dongle 130 may include a plurality of wireless communication dongle wireless radio systems, each capable of establishing a separate wireless link to one of the plurality of wireless IO devices (e.g., 180 or 190), such that the wireless communication dongle 130 may be in communication with a plurality of wireless IO devices (e.g., 180 and 190) via a plurality of wireless links.

The wireless communication dongle wireless radio system 199 may also operate in accordance with any BLE radio layer protocol with GFSK data modulation, as modified by the wireless IO device communication protocol of embodiments herein. To communicate with a wireless personal area network (WPAN), standards including IEEE 802.15 WPAN standards, Service Discovery Protocol (SDP), Radio Frequency Communications (RFCOMM) protocol, Telephony control protocol (TCS), Logical Link Control and Adaptation Protocol (L2CAP), or similar wireless standards may be used. Utilization of radiofrequency communication bands according to several example embodiments of the present disclosure may include bands used with the WPAN standards which may use frequency bands such as those within the 2.400 to 2.4835 GHz Industrial, Scientific, and Medical (ISM) band.

The present disclosure contemplates a computer-readable medium that includes instructions, parameters, and profiles 154 or receives and executes instructions, parameters, and profiles 154 responsive to a propagated signal, so that a device connected to the wireless communication dongle wireless radio system 199 may communicate voice, video or data to the wireless communication dongle 130. The wireless communication dongle 130 may include a set of instructions 154 that may be executed via a microcontroller 150, for example, to cause the wireless communication dongle 130 to perform any one or more of the methods or computer-based functions disclosed herein. For example, instructions 154 may include a particular example of a collision free wireless IO device network joining system 151, or other aspects or components. Application instructions 154 may also include any application processing drivers, or the like executing on information handling system 100 or wireless communication dongle 130.

The collision free wireless IO device network joining system 151 may utilize a computer-readable medium 152 in which one or more sets of instructions 154 may operate in part as firmware instructions executed by microcontroller 150 on the wireless communication dongle 130. The instructions 154 may embody one or more of the methods to execute the wireless IO device communications protocol as described herein. For example, instructions relating to the collision free wireless IO device network joining system 151 in firmware, software, or a combination including firmware algorithms, processes, and/or methods may be stored here. More specifically, instructions 154 may be executed by microcontroller integrated circuit 150 or other processing resources such as an embedded controller (EC) or the processor 101 to orchestrate transmission of data packets from one or more wireless IO devices 180 and 190 with the wireless communication dongle 130 during a data packet communication frames according to the wireless IO device communications protocol as described in embodiments herein. In other embodiments, the instructions 154 may be executed via a controller within the integrated wireless network interface device or wireless radio adapter 160 of the information handling system 100.

Memory 109 located and controlled by the wireless communication dongle 130 may contain computer-readable medium (not shown), such as RAM in an example embodiment. An example of memory 109 includes random access memory (RAM) such as static RAM (SRAM), dynamic RAM (DRAM), non-volatile RAM (NV-RAM), or the like, read only memory (ROM), another type of memory, or a combination thereof. The instructions, parameters, and profiles 154 of the collision free wireless IO device network joining system 151 may be stored in memory 109 on a computer-readable medium 152 such as a flash memory or magnetic disk in an example embodiment, or may be stored in main memory 102, static memory 103, or within drive unit 107. After an initial pairing process between the wireless communication dongle 130 and a plurality of wireless IO devices (e.g., 180 and 190), the microcontroller 150 may execute code instructions 154 of the collision free wireless IO device network joining system 151 to orchestrate transmission of a plurality of data packets from one or more of the wireless IO devices (e.g., 180 or 190) during one or more data packet communication frames, as described in embodiments of the wireless IO device communication protocol herein.

The wireless network interface device 160 in an embodiment may be capable of communication between the information handling system 100 and network 170 (e.g., LAN, WLAN, WAN, WLAN) in some embodiments. The wireless network interface device 160 may provide connectivity of the information handling system 100 to the network 170 via a dedicated link, a network access point (AP) or base station in an embodiment. The network 170 in other embodiments may be a wired local area network (LAN), a wireless personal area network (WPAN), a wireless Local Area Network (WLAN), such as a public Wi-Fi communication network, a private Wi-Fi communication network, or other non-cellular communication networks. In other embodiments, the network 170 may be a wired wide area network (WAN), a wireless wide area network (WWAN), such as a 4G LTE public network, or a 5G communication network, or other cellular communication networks, including future protocol communication networks such as upcoming 6G protocols under development. Connectivity to any of a plurality of networks 170, one or more APs for those networks, or to a docking station in an embodiment may be via wired or wireless connection. In some aspects of the present disclosure, the network interface device 160 may operate two or more wireless links. In other aspects of the present disclosure, the information handling system 100 may include a plurality of network interface devices, each capable of establishing a separate wireless link to network 170, such that the information handling system 100 may be in communication with network 170 via a plurality of wireless links.

In some embodiments, software, firmware, dedicated hardware implementations such as application specific integrated circuits, programmable arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations may include distributed processing, component/object distributed processing, and parallel processing. Alternatively, virtual computer system processing may be constructed to implement one or more of the methods or functionalities as described herein.

While the computer-readable medium is shown to be a single medium, the term “computer-readable medium” includes a single-medium or multiple-media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to store information received via carrier wave signals such as a signal communicated over a transmission medium. Furthermore, a computer readable medium may store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In some embodiments, dedicated hardware implementations such as application specific integrated circuits, programmable arrays and other hardware devices may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein may be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module may include software or firmware executing on hardware, including firmware embedded at a device. Hardware processing resources may include processors or controllers, such as an Intel® brand processor, ARM® brand processors, Qualcomm® brand processors, or other processors and chipsets, or other such devices for executing software on hardware capable of operating a relevant environment of the information handling system. In an embodiment, an information handling system 100 may include an integrated circuit or a board-level product having portions thereof that may also be any combination of hardware and software. Devices, hardware resources, or controllers executing software or firmware modules or programs that are in communication with one another need not be in continuous communication with each other, unless expressly specified otherwise. In addition, devices, hardware resources, or controllers executing firmware or software modules or programs that are in communication with one another may communicate directly or indirectly through one or more intermediaries.

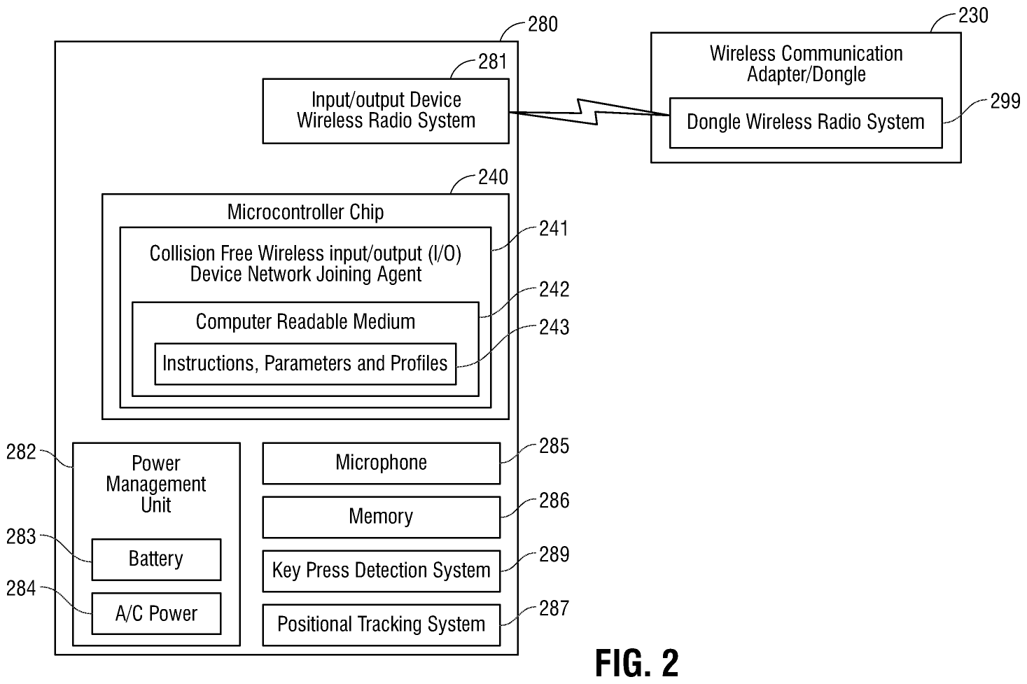

FIG. 2 is a graphical diagram illustrating a wireless communication dongle 230 wirelessly paired to a wireless input/output (IO) device 280 according to an embodiment of the present disclosure. As described previously, the wireless communication dongle 230 may be a dongle device paired to an information handling system or integrated within an information handling system in various embodiments herein. The wireless IO device 280 in various embodiments herein may comprise a mouse, a keyboard, an audio headset, earbuds, gaming controllers, or various peripheral virtual reality devices (e.g., headset or handheld controllers). A power management unit 282 with a battery 283 or A/C power charging adapter 284 may be on the wireless IO device 280 to provide power to the microcontroller chip 240, the speaker 288, the microphone 285, or other components of the wireless IO device 280. In an embodiment, the wireless IO device 280 may include a microcontroller chip 250 that may be any device or devices that execute instructions, parameters, and profiles 243 of a collision free wireless IO device network joining agent 241 at the wireless IO device 280 to synchronize collision-free delivery of a connection request from a wireless input/output IO devices 280 that has awoken from a low-power or sleep state to the wireless communications dongle 230 currently receiving data communication frames via a wireless IO device communication protocol. As described herein, the wireless communication dongle 230 in an embodiment may include a controller executing code instructions of a collision free wireless IO device network joining system to perform such a synchronization. Such a system may further orchestrate transmission of plural data packets from one or more paired wireless IO devices (e.g., 280) during any data packet communication frame in response to polling packets. Such an orchestration may be initiated by transmission from the dongle wireless radio system 299 to the IO device wireless radio system 281 of the one or more polling packets to each elicit plural data packets of a specified number and length, as described herein. The collision free wireless IO device network joining agent 241 of the wireless IO device 280 may operate to instruct the IO device wireless radio system 281 to transmit a request to connect upon waking of the wireless IO device 280 from a sleep mode at a reserved provisional time slot within an upcoming data packet communication frame with the wireless communication adapter/dongle 230 after data packets from another wireless IO device have been transmitted to the wireless communication adapter/dongle 230. As described, in some embodiments, the reserved provisional time slot may occur on a duty cycle such that not every data packet communication frame necessarily has the reserved provisional time slot. The wireless IO device 280 may await a designated data packet communication frame having a reserved provisional time slot among a plurality of frames to determine when to transmit a request to connect. A data packet communication frame is transmitted in response to a polling packet according to the received polling packets having coordinating instructions as to number of packets, packet lengths, and time slots to be used in the packet frame sent to the wireless communication adapter/dongle 230 from the other wireless IO device, as well as the wireless IO device 280.

The IO wireless radio system 281 in an embodiment may be capable of communication between the wireless IO device 280 and the wireless communication dongle 230 using a wireless link established under BLE radio layer protocol with GFSK data modulation, as modified by the wireless IO device communication protocol of embodiments herein, for example. The IO device wireless radio system 281 may provide connectivity of the wireless IO device 280 to the wireless communication dongle 230, external or integrated, and is operatively coupled to the information handling system via one or more wireless links. Such wireless links may be established pursuant to BLE radio layer protocol with GFSK data modulation, as modified by the wireless IO device communication protocol of embodiments herein, for example. Such wireless links may be established in an embodiment following an initial pairing between the wireless IO device 280 and the wireless communication dongle 230, which may include various handshake and identification methods under the BLE radio layer protocol with GFSK data modulation, as modified by the wireless IO device communication protocol of embodiments herein. During such an initial pairing session, the wireless communication dongle 230 in an embodiment may also transmit to the wireless IO device 280 an assigned radio frequency channel or a few designated wake channels (e.g., designated radiofrequency (RF) wakeup channels) selected from channels in a wireless Bluetooth® or BLE communications band upon which the wireless IO device 280 is instructed to transmit requests to connect to the wireless communications dongle 230 upon switching from a sleep mode to a waking state. This designated RF wakeup channel is monitored by a wireless communications dongle 230 and radio 299 when a timeout has been reached with no data communications from the wireless IO device 280.

The IO device wireless radio system 281 may operate in accordance with BLE radio layer protocol with GFSK data modulation, as modified by the wireless IO device communication protocol of embodiments herein. To communicate with a wireless personal area network (WPAN), standards including IEEE 802.15 WPAN standards, Service Discovery Protocol (SDP), Radio Frequency Communications (RFCOMM) protocol, Telephony control protocol (TCS), Logical Link Control and Adaptation Protocol (L2CAP), or similar wireless standards may be used. Utilization of radiofrequency communication bands according to several example embodiments of the present disclosure may include bands used with the WPAN standards which may use frequency bands such as those within the 2.400 to 2.4835 GHZ Industrial, Scientific, and Medical (ISM) band having plural channels therein.

The present disclosure contemplates a computer-readable medium 242 that includes instructions, parameters, and profiles 243 or receives and executes instructions, parameters, and profiles 243 responsive to a propagated signal, so that the IO device wireless radio system 281 may communicate voice, video or data to the wireless communication dongle 230, integrated or operatively coupled to the information handling system. In an embodiment in which the wireless IO device 280 comprises a mouse, the wireless IO device 280 may further include a position tracking system 287 capable of recording or tracking changes in position of the mouse with respect to the wireless communication dongle 230, as provided as input by the user of an information handling system. Such positional tracking system 287 may also determine a correlated position change for a cursor or visual graphical representation (e.g., game character, weapon, or camera view) within a software application executing on the information handling system operably connected to the wireless communication dongle 230. This positional information for the mouse or correlated changes to cursors or other graphical representations at the information handling system may be transmitted as data packets to the dongle wireless radio system 299 as described herein.

In another embodiment in which the wireless IO device 280 comprises a keyboard, the wireless IO device 280 may further include a key press detection system 289 that identifies specific keys pressed by a user. Such key press data may be transmitted as data packets to the dongle wireless radio system 299 as described herein. In yet another embodiment in which the wireless IO device 280 comprises a headset or earbuds, for example, the wireless IO device 280 may further include a microphone 285 for recording of audio user input. Such audio user input in an embodiment may be transmitted as data packets to the dongle wireless radio system 299 as described herein.

Instructions 243 of the collision free wireless IO device network joining agent 241 may be executed by the microcontroller chip 240, for example a controller integrated circuit, to transmit such data packets to the wireless communication dongle 230 at an information handling system pursuant to polling packets generated at the collision free wireless IO device network joining system operating at the wireless communication dongle 230 and transmitted to the wireless IO device 280. Such instructions 243 of the collision free wireless IO device network joining agent 241 may include instructions for transmission of a new connection request by the IO device wireless radio system 281, upon waking of the IO device 280 at a reserved provisional time slot within a data packet communication frame, after data packets are transmitted responsive to a polling packet received at the wireless IO device 280 from the wireless communication dongle 230. Identifying information for the wireless IO device 280 may be stored in memory 286 in an embodiment. Such identifying information in an embodiment may operate to identify the wireless IO device 280 as a device authorized to transceive data with the dongle 230, as well as information sufficient to identify the wireless IO device 280, such as a Media Access Control (MAC) address, IP address, or model number. The new connection request may include a data packet number and packet length for data from the wireless IO device seeking to send data on the data communication frame.

The wireless IO device 280 may, in some embodiments include a processing resource such as a microcontroller 240. Any of the processing resources described herein may be used and may operate to execute code that is either firmware or software code. Instructions 243 may include a collision free wireless IO device network joining agent 241 or other software applications or drivers detectable by the microcontroller 240 or other processing resource. The instructions 243 in an embodiment may reside completely, or at least partially, within the memory 286.

The wireless IO device 280 may include a set of instructions 243 that may be executed to cause the computer system such as the wireless IO device 280 to perform any one or more of the methods or computer-based functions disclosed herein. For example, instructions 243 may include a particular example of a collision free wireless IO device network joining agent 241, or other aspects or components. The collision free wireless IO device network joining agent 241 on the wireless IO device 280 may utilize a computer-readable medium 242 in which one or more sets of instructions 243 such as firmware executed with microcontroller chip 240, for example a controller integrated circuit with embedded firmware in an example embodiment. In other embodiments, the collision free wireless IO device network joining agent 241 may operate in part as software or firmware instructions executed on the wireless IO device 280. The instructions 243 may embody one or more of the methods as described herein. For example, instructions relating to the collision free wireless IO device network joining agent 241, firmware or software algorithms, processes, and/or methods may be stored here.

Memory 286 may contain computer-readable medium (not shown), such as RAM in an example embodiment. An example of memory 286 includes random access memory (RAM) such as static RAM (SRAM), dynamic RAM (DRAM), non-volatile RAM (NV-RAM), or the like, read only memory (ROM), another type of memory, or a combination thereof. Memory 286 may also comprise static memory containing computer-readable medium (not shown), such as NOR or NAND flash memory in some example embodiments. The instructions, parameters, and profiles 243 of the collision free wireless IO device network joining agent 241 may be stored in memory 286 on a computer-readable medium 242 such as a flash memory or magnetic disk in an example embodiment.

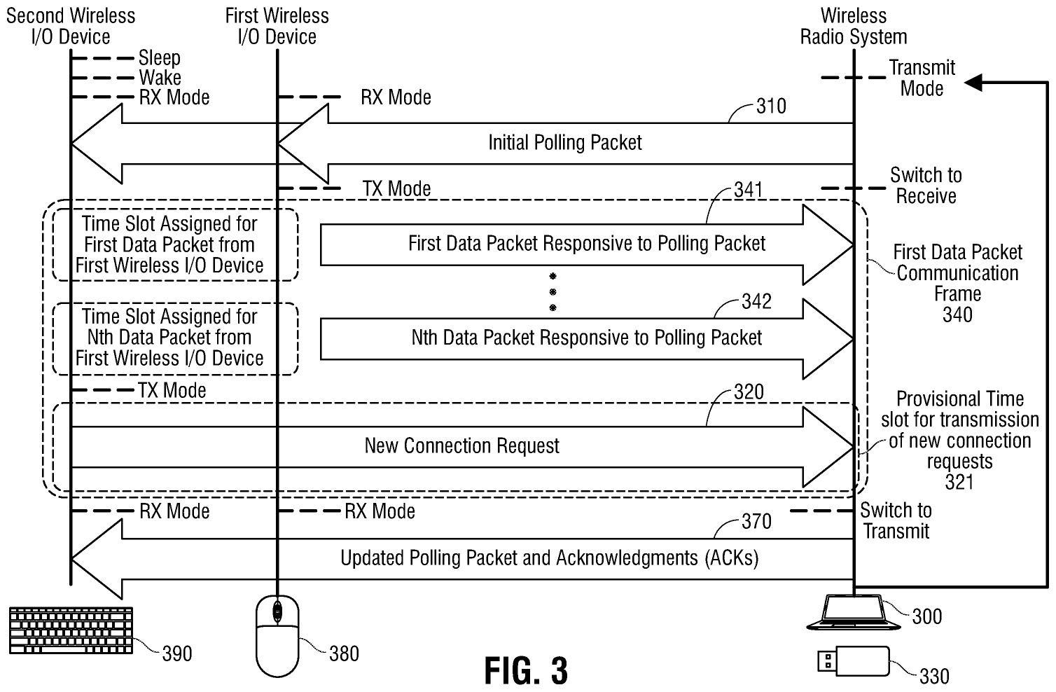

FIG. 3 is a block diagram illustrating a data packet communication frame between a wireless communications dongle or integrated wireless radio system and a first paired wireless input/output (IO) device orchestrated by a controller of the wireless communications dongle or integrated wireless radio system executing code instructions of the collision free wireless IO device network joining system and a second wireless IO device adding a new connection request in a reserved provisional time slot according to an embodiment of the present disclosure. A controller of a wireless communications dongle 330 or a wireless radio system of an information handling system 300 in an embodiment may schedule receipt of a plurality of data packets from a first paired wireless IO devices (e.g., mouse 380) between delivery of polling packets and data packets that include an acknowledgement header (ACK) to each of those one or more paired wireless IO devices (e.g., mouse 380 and keyboard 390). For case of explanation, the collision free wireless IO device network joining system in various embodiments herein may be described as executing at the wireless communications dongle 330 under such a wireless IO device communication protocol in some embodiments herein. However, it is also contemplated that the collision free wireless IO device network joining system may operate internally within an integrated wireless radio system of the information handling system 300 in an embodiment. In other embodiments, the wireless communication dongle 330 or integrated wireless radio system is capable of establishing wireless links with the wireless IO device 380 or keyboard 390 according to the Bluetooth® or Bluetooth® Low Energy (BLE) radio layer protocol with Gaussian Frequency Shift Keying (GFSK) data modulation, as modified by the wireless IO device communication protocol of embodiments herein.

As described herein, a controller for the wireless communications dongle 330 or internal wireless radio system of an information handling system 300 executing code instructions of the collision free wireless IO device network joining system in an embodiment may orchestrate scheduled delivery of a plurality of data packets from each of one or more wireless IO devices (e.g., mouse 380 and keyboard 390) in a data packet communication frame between delivery of ACK data packets to each of those one or more wireless IO devices (e.g., mouse 380 and keyboard 390). The wireless communications dongle 330 or internal wireless radio system of an information handling system 300 may engage in communication of data packets with a plurality of wireless IO devices, such as the mouse 380 and keyboard 390. In some cases, one of these wireless IO devices (e.g., keyboard 390) may have entered a sleep mode due to lack of use. In such a scenario, the wireless communications dongle 330 or internal wireless radio system of an information handling system 300 may orchestrate delivery of data packets from the first wireless IO device (e.g., mouse 380) while a second wireless IO device (e.g., keyboard 390) remains in a low-power or sleep state to conserve power.

A second wireless IO device 380 (e.g., keyboard) that is not currently transceiving data with the wireless communications dongle 330 or internal wireless radio system of the information handling system 300 may wake from a low power or sleep state. In such an embodiment, the second wireless IO device 390 may turn its radio on and place the radio in a receive (RX) mode to listen for polling packets transmitted by the wireless communications dongle 330 or internal wireless radio system of the information handling system 300. Upon waking, the second wireless IO device (e.g., keyboard 390) in an embodiment may need to transmit a new connection request (e.g., 320) to the wireless communications dongle 330 or internal wireless radio system of an information handling system 300 in order to begin transmitting data packets during an upcoming data packet communication frame. In existing systems, the second wireless IO device 390 may immediately turn on its radio and transmit the new connection request (e.g., 320), sometimes repeatedly, until it receives a response from the wireless communications dongle 330 or internal wireless radio system of an information handling system 300. Because the controller for the wireless communications dongle 330 or internal wireless radio system of an information handling system 300 in an embodiment orchestrates delivery of data packets from the first wireless IO device 380 during time slots currently assigned to the first wireless IO device 380, transmission of the new connection request (e.g., 320) by the second wireless IO device 390 during these time slots currently assigned to the first wireless IO device 380 may increase latency and lower throughput at the wireless communications dongle 330 or internal wireless radio system of an information handling system 300 of either the data packets transmitted from the first wireless IO device 380 or the connection request (e.g., 320) from the second wireless IO device 390.

A controller of the wireless communication dongle 330 or a wireless radio system of the information handling system 300 in an embodiment may initiate each of several consecutive data packet communication frames with operatively coupled wireless IO devices (e.g., the first wireless IO device 380 by transmitting an initial polling packet 310. A controller of the wireless communication dongle 330 or a wireless radio system of the information handling system 300 executing code instructions of the collision free wireless IO device network joining system may generate such an initial polling packet 310 in an embodiment to instruct the first wireless IO device 380 that is currently operatively connected to the wireless communication dongle 330 or a wireless radio system of the information handling system 300 to transmit an initial group or specified number (N) of first wireless IO device data packets 341 through 342 at initial first wireless IO device allotted data packet transmission time slots during a first data packet communication frame 340 between the wireless communication dongle 330 or a wireless radio system of the information handling system 300 and the operatively connected first wireless IO device 380. Upon transmission of the updated polling packet 310 in an embodiment, the controller for the wireless communications dongle 330 or the information handling system 300 may switch the wireless radio system into a receive mode to await the beginning of the first data packet communication frame 340 from the first wireless IO device 380.

The initial polling packet 310 preceding each such data packet communication frame (e.g., including 340) with the first wireless IO device 380 in an embodiment may further include a reserved provisional time slot 321 within the upcoming data packet communication frame 340 in which other wireless IO devices (e.g., keyboard 390) that are not currently transceiving data with the wireless communications dongle 330 or internal wireless radio system of the information handling system 300 may transmit a new request to connect 320 to the wireless communications dongle 330 or internal wireless radio system of the information handling system 300. This reserved provisional time slot 321 in an embodiment may comprise a short-duration (e.g., 100 μs, 150 μs, 200 μs) occurring between the Nth data packet 342 responsive to the polling packet 310, as transmitted by the first wireless IO device 380 and transmission of the next updated polling packet and acknowledgements (ACKs) 370. This reserved provisional time slot time span adds minimal latency to the data packet communication frame. A second wireless IO device 390 seeking to join may detect a data packet number and data packet length and monitor the data packets transmitted from the first wireless IO device 380 before transmitting a request to connect 320 in the reserved provisional time slot 321 in some embodiments. In other embodiments, the second wireless IO device may use a queue based timer control to determine a number of data packets and data packet lengths to be transmitted from a first wireless IO device 380 and upon a first packet being transmitted shut down the radio until the last packet is scheduled to be transmitted before the reserved provisional time slot 321. Then the second wireless IO device 390 may turn on it radio in transmit (TX) mode and transmit the request to connect 321 in the reserved provision time slot 321 in an embodiment.

In some embodiments, the additional timespan in the data packet communication frame 340 for the reserved provisional time slot 321 may not occur during every frame 340, but may operate on a duty cycle. For better performance and reduced latency, the reserved provisional timeslot 321 may occur for the extended span of time during a designated data packet communication frame that is cycled among a plurality of data packet communication frames 340 in some embodiments. For example, the added time for the reserved, provisional time slot 321 may occur every fourth data packet communication frame 340 (e.g., every 2 ms) in one embodiment. A second wireless IO device 390 seeking to join will await the next designated data packet communication frame having a reserved provisional time slot 321. The frame with the reserved provisional timeslot 321 may be identified via a header or instruction in the polling packet 310 preceding the designated data packet communication frame in example embodiments. Transmission of the new connection request 320 by the second wireless IO device 390 during the provisional time slot 321 in the various embodiments above may avoid collision between the new connection request 320 and any of the wireless IO device data packets (e.g., 341 to 342) transmitted by the first wireless IO device 380 to the wireless communications dongle 330 or internal wireless radio system of the information handling system 300 during the initial first wireless IO device allotted data packet transmission time slots.

In another embodiment, this connection request 320 may include an identification of the model number or various default communication metrics for the second wireless IO device 390 or other identifying information for the keyboard 390 or other IO devices that the wireless communications dongle 330 or the information handling system 300 may use to access stored information identifying such default communications metrics. For example, the connection request 320 may include a standard data packet transmission rate (e.g., 6,000 packets per second), or standard data packet transmission length (e.g., 23 bytes or 184 bits) for the second wireless IO device 390 or other IO devices. As another example, the connection request 320 may include identification for the second wireless IO device 390 or other IO devices that is associated with a profile stored at the wireless communications dongle 330 or the information handling system 300 providing such standard data packet transmission rate or standard data packet transmission length.

The controller may ensure that, during at least a portion of the upcoming data packet communication frame 340 in which time slots have been allocated to the first wireless IO device 380, the wireless communication dongle 330 or a wireless radio system of the information handling system 300 and the second wireless IO device 390 remains in a receive mode to receive data packets from the first wireless IO device 380 in accordance with the number of packets prescribed and the duration (e.g., based on packet lengths) from the first wireless IO device 380. The second wireless IO device 390 may stay in a RX mode to listen for transmission of each of the data packets 341 to 342 responsive to the polling packet 310, as transmitted by the first wireless IO device 380 in order to determine when the provisional time slot 321 is to occur. In some embodiments, the second wireless IO device 390 may also remain in RX mode to listen for a designated data packet communication frame 340 that occurs in a duty cycle of frames 340 having the reserved provisional time slot 321. In other words, in some embodiments, not every data packet communication frame 340 necessarily must have a reserved provisional timeslot 321. Upon detection at the second wireless IO device 390 of transmission of the Nth data packet 342 transmitted in response to the polling packet 310, the second wireless IO device 390 may switch its radio to TX mode in order to transmit the new connection request 320 within the reserved provisional time slot 321. This new connection request 320 in an embodiment may include an identification requesting a specific number of data packets or a specified data packet length for that number of packets that the second wireless IO device may accommodate in data packet communication frames in some embodiments.

The wireless communications dongle 330 or internal wireless radio system of the information handling system 300 may receive this request to connect 320 from the second wireless IO device 390 (e.g., keyboard) in the reserved provisional time slot, and then may respond to the request to connect 320 by transmitting a second, updated polling packet 370. The second, updated polling packet 370 instructs each of the wireless IO devices (e.g., mouse 380 and keyboard 390) operatively connected with the wireless communications dongle 330 or internal wireless radio system of the information handling system 300 that have requested to connect and have been instructed to transmit a specified number of data packets (e.g., N and M) at a specified data packet length and at specified time slots during a second data packet communication frame between the wireless communications dongle 330 or internal wireless radio system of the information handling system 300 and each of the operatively connected wireless IO devices (e.g., mouse 380 and keyboard 390). In such a way, the collision free wireless IO device network joining system may orchestrate a collision-free method for a second wireless IO device to join a network in which the wireless communications dongle 330 or internal wireless radio system of the information handling system 300 is currently operatively connected to a first wireless IO device. This may decrease the frequency of ACK data packets transmitted, latency, and the frequency of mode-switching described herein with respect to existing systems, improve overall user experience, and may further decrease power consumed by rapid mode-switching.

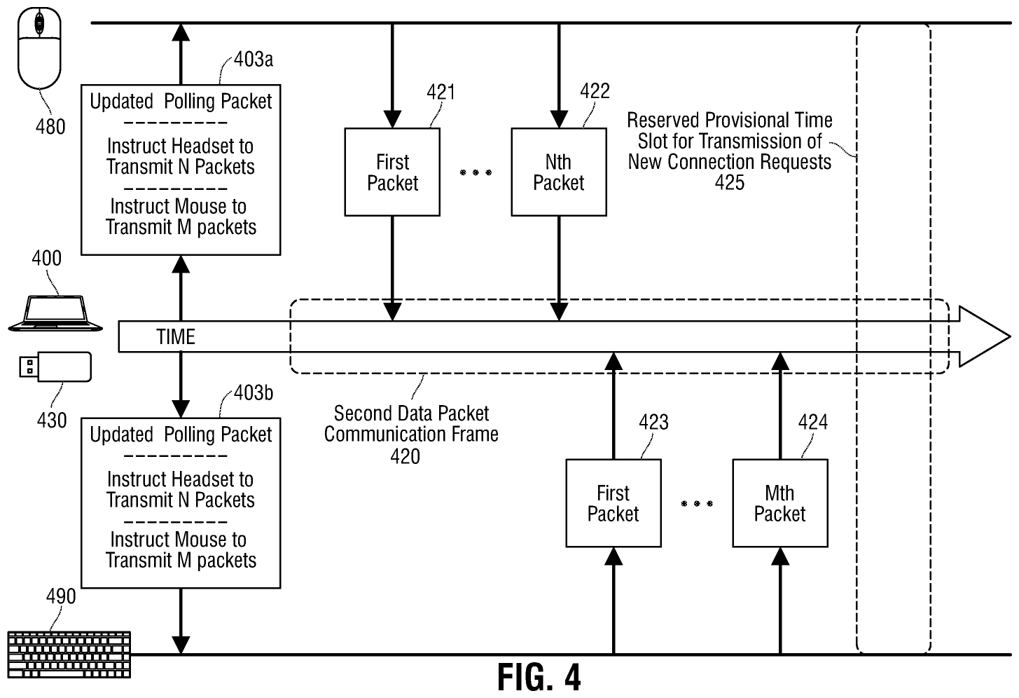

In an embodiment, the updated polling packet 370 may include an acknowledgement header (ACK) identifying the number (N) of packets received from the first wireless IO device 380 during the data packet communication frame 340. For example, in an embodiment in which the Nth packet is the fifth of five packets allotted to the wireless IO device for transmission within the data packet communication frame 340 within the initial polling packet 310, such an updated polling packet 370 may acknowledge receipt of five packets. The updated polling packet 370 in an embodiment may further include updated instructions for synchronizing transmission of data packets within a second, later data packet communication frame, as described in greater detail below with respect to FIG. 4. For example, the updated polling packet 370 may, at the very least, provide an updated time for initiation of such a second, later data packet communication frame, as well as a number (M) of data packets to be included within an initial group of second wireless IO device data packets, lengths of those packets, and data packet transmission time slots allotted to transmission of those data packets from the second wireless IO device 380.

In such an embodiment, the updated polling packet 370 may or may not further adjust one or more of the specified data packet number, specified data packet length, or allotted time slots for the first wireless IO device 380. For example, in an embodiment, the updated polling packet 370 identifying an updated time for initiation of a second, later data packet communication frame may also provide a number (N) of data packets to be included within an updated group of first wireless IO device data packets, equivalent to the number (N) of data packets included within the initial group of first wireless IO device data packets (e.g., 341 to 342). In another example, in an embodiment, the updated polling packet 370 may also provide updated first wireless IO device allotted data packet transmission time slots having the same positions within the second data packet communication frame as the positions of the initial first wireless IO device allotted data packet transmission time slots at which data packets 341 to 342 were transmitted within the first data packet communication frame 340. In other embodiments, one or more of these values for the number or length of data packets within the updated group of first wireless IO device data packets, or updated first wireless IO device allotted data packet transmission time slots may be changed or adjusted from the values of the number or length of packets within the initial group of first wireless IO device data packets (e.g., 341 and 342), or initial first wireless IO device allotted data packet transmission time slots given within the initial polling packet 310.

FIG. 4 is a block diagram illustrating a data packet communication frame between a wireless communications dongle or integrated wireless radio system and a plurality of paired wireless input/output (IO) devices orchestrated by a controller of the wireless communications dongle or integrated wireless radio system executing code instructions of the collision free wireless IO device network joining system according to an embodiment of the present disclosure. As described herein, a second wireless IO device 490 (e.g., keyboard) may turn its radio on and place the radio in a receive (RX) mode to listen for polling packets (e.g., initial polling packet 310 of FIG. 3) transmitted by the wireless communications dongle 430 or internal wireless radio system of the information handling system 400 upon waking from a sleep state. The second wireless IO device 490 in an embodiment may then receive the initial polling packet (e.g., initial polling packet 310 of FIG. 3) that instructs the first wireless IO device 480 (e.g., mouse) to transmit a plurality of data packets at specified time slots during a first data packet communication frame (e.g., 340 of FIG. 3). The second wireless IO device 490 may detect transmission of the final data packet assigned for transmission from the first wireless IO device 480 during the first data packet communication frame (e.g., 340 of FIG. 3), and switch its radio to TX mode. As described with respect to FIG. 3, the second wireless IO device 490 may then transmit a new connection request (e.g., 320 of FIG. 3) to the wireless communication dongle 430 or wireless radio system of the information handling system 400 during a reserved provision time slot of short duration (e.g., up to 200 μs) between transmission of the last data packet (e.g., 343 of FIG. 3) assigned to the first wireless IO device 480 during an initial polling packet (e.g., 310 of FIG. 3) and transmission of an updated polling packet 403a or 403b by the wireless communication dongle 430 or wireless radio system of the information handling system 400. The wireless communications dongle 430 or internal wireless radio system of the information handling system 400 may receive this request to connect (e.g., 320 from FIG. 3) from the second wireless IO device 490 (e.g., keyboard), and then may respond to the request to connect by transmitting a second, updated polling packet (e.g., 370 of FIG. 3 or 403a and 403b) that instructs each of the wireless IO devices (e.g., 480 and 490) operatively connected with the wireless communications dongle 430 or internal wireless radio system of the information handling system 400 that have requested to connect (e.g., both keyboard and mouse) to transmit a plurality of data packets of a specified length and at specified time slots during a second data packet communication frame 420 between the wireless communications dongle 430 or internal wireless radio system of the information handling system 400 and each of the operatively connected wireless IO devices 480 and 490.

The controller of the wireless communications dongle 430 or the information handling system 400 executing code instructions of the collision free wireless IO device network joining system in an embodiment may determine a wireless IO device specified frame data packet number (e.g., N packets for the first wireless IO device 480 and M packets for the second wireless IO device 490), a wireless IO device specified frame data packet length, or allotted data packet transmission time slots for receipt of data packets transmitted from the wireless IO devices 480 and 490. During the second data packet communication frame 420, the first wireless IO device 480 (e.g., mouse) may be instructed via the updated polling packet 403a to transmit an updated specified number or group (N) of first wireless IO device data packets (e.g., 421 to 422). These data packets (e.g., 421 to 422) may be referred to herein as an updated group of first wireless IO device data packets due to the fact that the first wireless IO device 480 may have transmitted an initial group of first wireless IO device data packets during the previous, first data packet communication frame (e.g., 340 from FIG. 3). The updated polling packet 404a may also instruct the second wireless IO device 490 (e.g., keyboard) to transmit an initial specified number (M) or group of second wireless IO device data packets (e.g., 423 to 424). These M data packets (e.g., 423 to 424) may be referred to herein as an initial specified number or group of second wireless IO device data packets since the second wireless IO device 490 has not sent any previous data packets during the first data packet communication frame (e.g., 340 from FIG. 3).

In an embodiment, the controller of the wireless communications dongle 430 or the information handling system 400 executing code instructions of the collision free wireless IO device network joining system may determine the specified number (N) for the updated group of first wireless IO device data packets, the specified number (M) for the initial group of first wireless IO device data packets, or any data packet lengths based on default initial values that apply to each of the operatively connected wireless IO devices 480 or 490 identifiable based on information given within the request to connect. For example, the controller of the wireless communications dongle 430 or the information handling system 400 executing code instructions of the collision free wireless IO device network joining system may determine an initial wireless IO device specified frame data packet number of four, and an initial wireless IO device specified frame data packet length of 23 bytes (B), or initial allotted data packet transmission time slots, with each slot occurring every 0.000167 seconds (e.g., 167 μs) for receipt of data packets transmitted from the wireless IO device 490 within a data packet communication frame having a total length of 0.000833 seconds plus any delay or extra times included, or about 1,000 μs.

In another example embodiment, the controller of the wireless communications dongle 430 or the information handling system 400 executing code instructions of the collision free wireless IO device network joining system may determine the specified number (N) for the updated group of first wireless IO device data packets, the specified number (M) for the initial group of first wireless IO device data packets, or any data packet lengths based on requests made by the first or second wireless IO devices 480 and 490, respectively. For example, as described above with respect to FIG. 3, the new connection request 320 in an embodiment may include a request to transmit a specific number of data packets or a specified data packet length for that number of packets. The controller of the wireless communications dongle 430 or the information handling system 400 executing code instructions of the collision free wireless IO device network joining system in an embodiment may attempt to accommodate all requests received from the wireless IO devices 480 and 490. In an embodiment, collision free wireless IO device network joining system may modify the number or length of data packets allotted for transmission from the first or second wireless IO devices 480 or 490 based on the available duration of each scheduled data packet communication frame (e.g., 420) or other factors that may impact report rate, throughput, latency, lost packets, or other parameters of performance or reliability for the wireless IO devices 480 or 490. The specified number of data packets N or M instructed in a polling packet for wireless IO devices 480 or 490 respectively is adjustable on the fly via changes to upcoming polling packets for example and for a variety of reasons including detected executing software applications and performance, error correction, radio conditions, or other reasons.

The controller of the wireless communications dongle 430 or the information handling system 400 may instruct the wireless radio system to transmit the updated polling packet 403a or 403b containing the specified number (N) for the updated group of first wireless IO device data packets, the updated first wireless IO devices allotted data packet transmission time slots (e.g., including the times at which the first wireless IO device transmits data packets 421 to 422), the specified number (M) for the initial group of second wireless IO device data packets, and the initial second wireless IO device allotted data packet transmission time slots (e.g., including the times at which the first wireless IO device transmits data packets 423 to 424). This updated polling packet (403a or 403b) in an embodiment may synchronize communication between the wireless communications dongle 430 or the information handling system 400 and the wireless IO devices 480 and 490 for the second data packet communication frame 420 beginning at a specified time and having the specified duration (e.g., 0.0138 seconds).

At the time specified within the updated polling packet 403a or 403b in an embodiment, the data packet communication frame 420 may begin with transmission of a first packet 421 from the first wireless IO device 480 responsive to the updated polling packet 403a or 403b from the first wireless IO device 480, and receipt of that packet 421 at the wireless radio system of the wireless communication dongle 430 or information handling system 400. The first wireless IO device 480 in an embodiment may proceed to transmit a specified number (N) of data packets of the entire updated group of first wireless IO device data packets (e.g., including 421 to 422), according to the instructions given within the updated polling packet 403a or 403b. The second wireless IO device 490 in an embodiment may then proceed to transmit a specified number (M) of data packets of the initial group of second wireless IO device data packets (e.g., including 423 to 424), according to the instructions given within the updated polling packet 403a or 403b. In some embodiments where a plural wireless IO device mode is available at a wireless communication dongle 430, the second data packet communication frame 420 in such an embodiment may then extend beyond receipt of the Mth packet 424 from the second wireless IO device 490 to include an abbreviated time span for the reserved provisional time slot 425. As before, the reserved provisional time slot 425 may be used for transmission of new connection requests from additional wireless IO devices (e.g., other than 480 or 490) in the plural wireless IO device mode. Similarly, the reserved provisional time slot 425 may also only occur in designated frames on duty cycle in some embodiments. In some other embodiments, the time slots allotted to the second wireless IO device 490 may precede the time slots allotted to the first wireless IO device 480.

Following the second data packet communication frame 420, at the end of a time period determined by the number of packets expected, packet lengths, and any spacing time, the controller of the wireless communications dongle 430 or other wireless radio adapter of the information handling system 400 may switch to transmit mode and transmit to each of the paired wireless IO devices 480 and 490 (e.g., mouse and keyboard) an acknowledgement identifying the number of packets (e.g., N and M, respectively) received during the second data packet communication frame 420 from each of the paired wireless IO devices 480 and 490 in the next polling packet and providing an instruction in the updated polling packet with the same or changed specified data packet numbers for the next data packet communication frame. In such a way, the collision free wireless IO device network joining system may orchestrate a collision-free method for a second wireless IO device 490 to join a network in which the wireless communications dongle 430 or internal wireless radio system of the information handling system 400 is currently operatively connected to a first wireless IO device 480. This may decrease the frequency of ACK data packets transmitted, latency, and the frequency of mode-switching described herein with respect to existing systems, improve overall user experience, and may further decrease power consumed by rapid mode-switching.

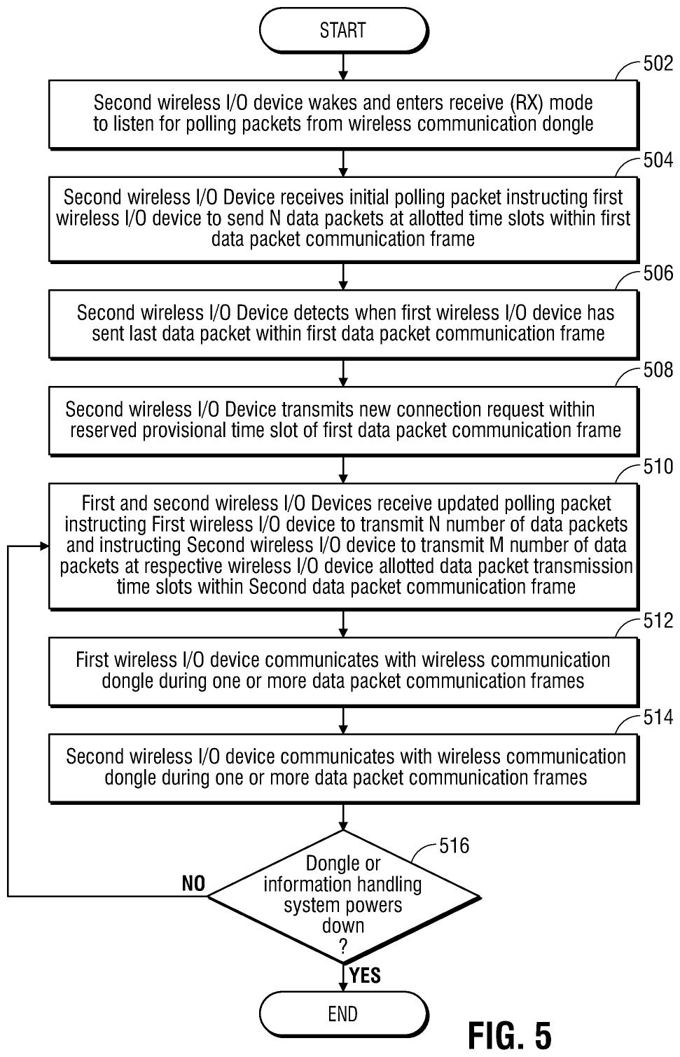

FIG. 5 is a flow diagram illustrating a method of orchestrating collision-free joining of a second wireless input/output (IO) device to a network in which a first wireless IO device is in communication with a wireless communication dongle according to an embodiment of the present disclosure. As described herein, upon waking from a sleep state, a second wireless IO device in an embodiment may need to transmit a new connection request in order to establish communications with a wireless communications dongle or internal wireless radio system of an information handling system in order to begin transmitting data packets during an upcoming data packet communication frame. However, the controller for the wireless communications dongle or internal wireless radio system of an information handling system in an embodiment may be orchestrating delivery of data packets from a first wireless IO device already in established communication with the wireless communication dongle during time slots currently assigned to the first wireless IO device. In such a case, transmission of the new connection request by the second wireless IO device during any of these time slots currently assigned to the first wireless IO device may pose an increased risk of collision and lack of receipt at the wireless communications dongle or internal wireless radio system of an information handling system of either the data packets transmitted from the first wireless IO device or the connection request from the second wireless IO device. The controller for the wireless communications dongle or internal wireless radio system of an information handling system executing code instructions of the collision free wireless IO device network joining system may further orchestrate transmission of the new connection request from the second wireless IO device during an abbreviated extra time span serving as a reserved provisional time slot following the time slots currently allotted to the first wireless IO device in a data packet communication frame under the disclosed wireless communication protocol in order to avoid such collision. The reserved provisional time slot may not be in every data packet communication frame as well in some embodiments, but may be available only on designated frames of a duty cycle of data packet communication frames.

At block 502, a second wireless IO device may exit sleep mode with movement or input and turn on its wireless radio system. For example, the second wireless IO device 390 (e.g., keyboard) in an embodiment may wake upon receiving some form of user input, such as a keyboard recognizing a keystroke, or a mouse undergoing movement, for example. This may occur while the wireless communication dongle 330 or the wireless radio system of the information handling system 300 is currently transceiving data with a first wireless IO device 380 (e.g., mouse). Upon waking in response to such a received or detected user input, the second wireless IO device 390 may turn on its wireless radio system.

At block 504, the first and second wireless IO devices may receive an initial polling packet instructing the first wireless IO device to send one or more data packets during identified time slots within a next data packet communication frame. For example, the second wireless IO device 390 in an embodiment may receive the initial polling packet 310 that instructs the first wireless IO device 380 to transmit a plurality of data packets at specified time slots during a first data packet communication frame 340. The second wireless IO device 390 may use this information from the initial polling packet 310 to determine when the first wireless IO device 380 has transmitted its final assigned data packet (e.g., Nth data packet 342) within the data packet communication frame 340 in an embodiment. Further, the received polling packet 310 may also provide information or instructions of whether it is designated among a duty cycle of frames to have a reserved provisional timeslot 321 in some embodiments where not every frame contains a reserved provisional timeslot 321. This embodiment may assist in improving performance further by reducing average frame latency even more over a cycle of frames since the reserved provisional time slot 321 is likely infrequently needed.

The second wireless IO device in an embodiment at block 506 may detect when the first wireless IO device has sent its last data packet within the first data packet communication frame. For example, the second wireless IO device 380 in an embodiment may remain in RX mode to determine when the first wireless IO device 380 has transmitted its Nth data packet 342, as allotted to the first wireless IO device 380 within the initial polling packet 310. In one embodiment, the second wireless IO device 390 may monitor the data packets transmitted by the first wireless IO device 380 in the data packet communication frame 340. In other embodiments, the number of data packets and data packet length expected from the first wireless IO device 380 may cause a timer based queue control to be used for any data packet communication frame 340 having a reserved provisional time slot 321. Upon determining the first data packet 341 from the first wireless IO device 380 is transmitted, the second wireless IO device 390 may then turn off its radio until the last data packets 342 from the first wireless IO device 380 are scheduled to be sent in some embodiments. Then the second wireless IO device 390 may turn on its radio in transmit mode and transmit a request to connect 320 in the reserved provisional time slot 321. As described herein, a reserved provisional time slot 321 between transmission of the Nth data packet 342 by the first wireless IO device 380 and transmission of the updated polling packet 370 by the wireless communication dongle 330 or the wireless radio system of the information handling system 300 may present a short duration window 321 in which the second wireless IO device 390 may transmit a new connection request 320 without risking collision with other data packets transmitted to or by the wireless communication dongle 330 or the wireless radio system of the information handling system 300.

At block 508, the second wireless IO device may transmit a new connection request within the reserved provisional time slot of the first data packet communication frame in an embodiment. For example, the second wireless IO device 390 may transmit a new request to connect 320 to the wireless communications dongle 330 or internal wireless radio system of the information handling system 300 during the reserved provisional time slot 321 within the upcoming data packet communication frame 340.

The wireless IO device 380 may place its wireless radio system in transmit (TX) mode and transmit a new connection request 320 to the wireless communication dongle 330 or wireless radio system of the information handling system 300, during the reserved provisional time slot of the first data packet communication frame 340. By transmitting this new connection request 320 during the reserved provisional time slot only, the controller for the wireless communication dongle 330 or the wireless radio system of the information handling system 300 may ensure that the transmission of the request to connect 320 does not interfere with transmission of the data packets 341 and 342 from the first wireless IO device 380 or any polling packet 370 from the wireless communication dongle 330 or wireless radio system.

At block 510, the first and second wireless IO devices may receive an updated polling packet instructing the first wireless IO device to transmit a number (N) of data packets and instructing the second wireless IO device to transmit a number (M) of data packets within an upcoming or second data packet communication frame. For example, the wireless communications dongle 330 or internal wireless radio system of the information handling system 300 may receive the request to connect 320 transmitted from the second wireless IO device 390 (e.g., keyboard) at block 508, and then may respond to the request to connect 320 by transmitting a second, updated polling packet 370. In an embodiment, such a second, updated polling packet 370 may instruct transmission of (N) data packets from the first wireless IO device 380 and transmission of (M) data packets from the second wireless IO device 390 operatively connected with the wireless communications dongle 330 or internal wireless radio system of the information handling system 300. More specifically, the updated polling packet 370 may instruct transmission of a plurality of a specified number of data packets of a specified length and at specified time slots during a second data packet communication frame between the wireless communications dongle 330 or internal wireless radio system of the information handling system 300 and each of the operatively connected wireless IO devices (e.g., including a first wireless IO device 380 and the second wireless IO device 390). In an example embodiment, the specified number of data packets for the first wireless IO device and the second wireless IO device 380 may be determined based on a stored profile associated with the identified type of first wireless IO device or the second wireless IO device. In other embodiments, the specified number of data packets for the first wireless IO device and the second wireless IO device may depend on detected executing software applications on the information handling system, wireless radio frequency conditions, wireless IO performance selections from a user, or others.

In another example embodiment described with respect to FIG. 4, the controller of the wireless communications dongle 430 or the information handling system 400 executing code instructions of the collision free wireless IO device network joining system in an embodiment may determine a wireless IO device frame data packet number (e.g., N packets for the first wireless IO device 490 and M packets for the second wireless IO device 480), a wireless IO device frame data packet length, or allotted data packet transmission time slots for receipt of data packets transmitted from the wireless IO devices 480 and 490, respectively. During the second data packet communication frame 420, the first wireless IO device 480 (e.g., mouse) may be instructed via the updated polling packet 403a to transmit an updated number (N) of first wireless IO device data packets (e.g., 421 to 422). The updated polling packet 404a may also instruct the second wireless IO device 490 (e.g., keyboard) to transmit an initial number (M) of second wireless IO device data packets (e.g., 423 to 424). In such a way, the collision free wireless IO device network joining system may orchestrate a collision-free method for a second wireless IO device 490 to join a network in which the wireless communications dongle 430 or internal wireless radio system of the information handling system 400 is currently operatively connected to a first wireless IO device 480. This may decrease the frequency of ACK data packets transmitted, latency, and the frequency of mode-switching described herein with respect to existing systems, improve overall user experience, and may further decrease power consumed by rapid mode-switching.

The first wireless IO device in an embodiment may communicate one or more selected number of data packets (N) during one or more data packet communication frames with the wireless communication dongle at block 512. For example, in an embodiment described with respect to FIG. 4, the first wireless IO device 480 may communicate N data packets in one or more data packet communication frames (e.g., 420) with the wireless radio system of the wireless communications dongle 430 or the information handling system 400.

At block 514, the second wireless IO device in an embodiment may communicate one or more selected number of data packets (M) during data packet communication frames with the wireless communication dongle. For example, in an embodiment described with respect to FIG. 4, the second wireless IO device 490 may communicate M data packets on one or more data packet communication frames (e.g., 420) with the wireless radio system of the wireless communications dongle 430 or the information handling system 400.

The controller of the wireless communication dongle or the information handling system in an embodiment at block 516 may determine whether the dongle or the information handling system has powered down. If the wireless communication dongle or the information handling system has powered down in an embodiment, there may be no need or no capability to switch the dongle wireless radio system to a RX mode for further communication with any wireless IO devices, and the method may then end. If the wireless communication dongle or the information handling system has not powered down in an embodiment, the method may proceed back to block 510 to transmit a third, updated polling packet instructing the first and second wireless IO devices for transmission of data packets in allotted time slots during future data packet communication frames.

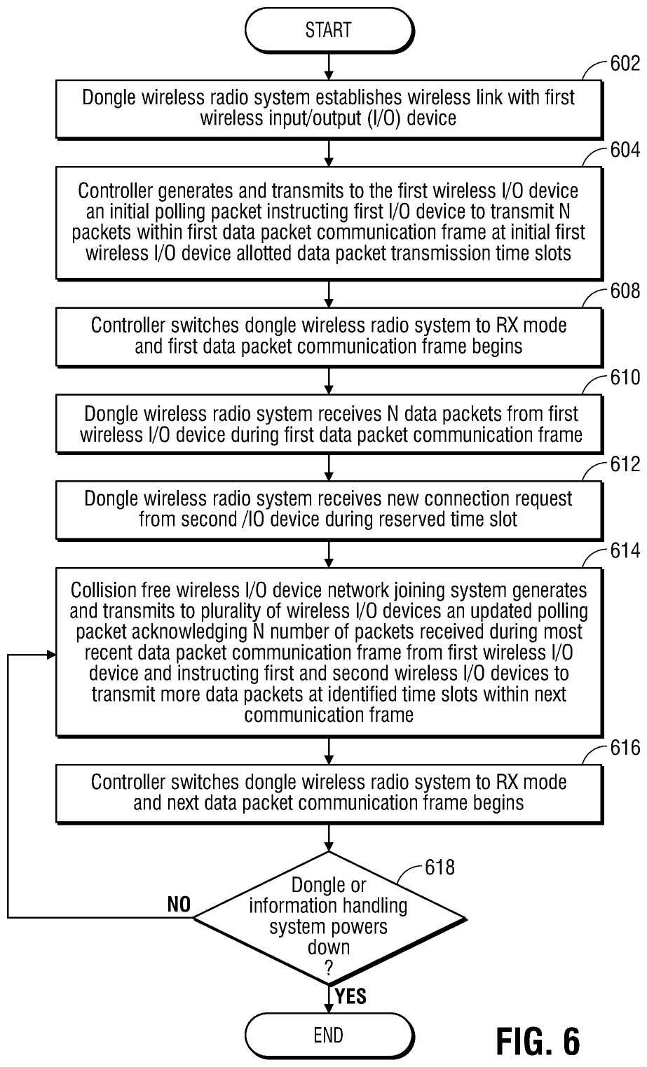

FIG. 6 is a flow diagram illustrating a method of orchestrating transmission of data packets from one or more wireless IO devices to a wireless communication dongle during a data packet communication frame and switching to add additional wireless IO devices with limited risk of data packet collision and with limited latency according to an embodiment of the present disclosure. As described herein, many manufacturers of wireless IO devices (e.g., mouse, keyboard, headset, virtual reality peripheral devices) for pairing wirelessly with an information handling system build these devices to provide the most basic or rudimentary communication capabilities. For example, many existing wireless IO devices are designed to communicate with a wireless communications dongle using a one reception/one transmission (1RX/1TX) format in which each time the wireless communications dongle operating in receive mode receives a data packet, it must then switch to transmit mode and transmit an ACK data packet back to the wireless IO device from which the initial data packet was received. The wireless communications dongle may then switch back to a receive mode to receive the next data packet from the wireless IO device. This process may be repeated each time a new data packet is generated at the wireless IO device, for example.

Each of these transmission/reception mode switches consumes power, causes delay and reduced throughput, and increases use of airtime causing band congestion. This may further cause the customer to experience reduced performance between their input via the wireless IO device (e.g., movement of the mouse) and the corresponding feedback displayed by the information handling system (e.g., movement of the cursor), or may cause the cursor to jump suddenly from one position to another (e.g., when the wireless mouse opts to skip resend of the missed packet). As a result, existing systems employing this 1RX/1TX approach may fail to meet customer needs for operational data throughput during execution of latency-sensitive software applications such as gaming applications or other high definition audio/visual applications. The collision free wireless IO device network joining system in an embodiment may orchestrate scheduled reception of a plurality of data packets in a data packet communication frame from one or more wireless IO devices between transmission of ACK data packets in polling packets to any one or more of those wireless IO devices to provide higher data throughputs and improved performance under the wireless IO device communication protocol of embodiments herein. Further, the collision free wireless IO device network joining system provides for a reserved provisional time slot in the data packet communication frame in abbreviated additional time to allow the dongle to receive a new connection request from another wireless IO device to switch from a single wireless IO device mode to a plural wireless IO device mode according to embodiments herein.

At block 602, the wireless radio system in an embodiment may establish a wireless link with a first wireless IO device. For example, in an embodiment described with respect to FIG. 3, the wireless radio system of the wireless communications dongle 330 or the information handling system 300 may establish communication with a first wireless IO device 380, such as a wireless headset, for communication of data packets during a first data packet communication frame 340.

At block 604, the controller of the wireless communication dongle or the information handling system may generate and transmit to a first wireless IO devices an initial polling packet. For example, the controller of the wireless communication dongle 330 or a wireless radio system of the information handling system 300 executing code instructions of the collision free wireless IO device network joining system may generate such an initial polling packet 310 in an embodiment to instruct the first wireless IO device 380 that is currently operatively connected to the wireless communication dongle 330 or a wireless radio system of the information handling system 300 to transmit an initial group of first wireless IO device data packets at initial first wireless IO device allotted data packet transmission time slots (e.g., 341 and 342) during a first data packet communication frame 340 between the wireless communication dongle 330 or a wireless radio system of the information handling system 300 and the operatively connected first wireless IO device 380.

The initial polling packet 310 preceding each such data packet communication frame (e.g., including 340) with the first wireless IO device 380 in an embodiment is timed to further include an abbreviated extra span of time to serve as a reserved provisional time slot 321 within the upcoming data packet communication frame 340 in which other wireless IO devices (e.g., keyboard 390) that are not currently transceiving data with the wireless communications dongle 330 or internal wireless radio system of the information handling system 300 may wait and then transmit a new request to connect 320 to the wireless communications dongle 330 or internal wireless radio system of the information handling system 300 after detecting that the data packets from the first wireless IO device 380 have been sent in the data packet communication frame 340. Reserving the provisional time slot 321 for the new connection request 320 transmission in the data packet communication frame 340 in an embodiment may avoid collision between the new connection request 320 and any of the initial group of first wireless IO device data packets 341 and 342 transmitted by the first wireless IO device 380 to the wireless communications dongle 330 or internal wireless radio system of the information handling system 300 during the initial first wireless IO device allotted data packet transmission time slots. In an embodiment, the reserved provisional time slot 321 may be of an abbreviated duration, such as 100 μs, to allow time for a new connection request 320 but limit any significant impact on the data packet communication frame 340. In other embodiments, the reserved provisional time slot 321 may be up to 200 μs and still with limited additional latency. In yet other embodiments, the reserved provisional time slot 321 is contemplated to occur at any number of durations of extended time in the data packet communication frame 340.

At block 608, the controller for the wireless communication dongle or the information handling system may switch the wireless radio system to RX mode for receipt of a first data packet within a data packet communication frame. For example, in an embodiment described with respect to FIG. 3, upon transmission of the initial polling packet 310 with instructions for specified packet number and specified packet length for the first wireless IO device 380 in an embodiment, the controller for the wireless communications dongle 330 or the information handling system 300 may switch the wireless radio system into a receive mode. In a receive mode, the wireless communication dongle 330 awaits the beginning of the data packet communication frame 340 with the first wireless IO device 380. At a time slot specified within the initial polling packet 310 in an embodiment, the data packet communication frame 340 may begin with receipt of a first data packet 341 of among the specified data packet number (e.g., N) from the first wireless IO device 380 responsive to the initial polling packet 310.

The wireless radio system of the wireless communication dongle or information handling system in an embodiment at block 610 may receive a plurality of data packets from the first wireless IO device during a first data packet communication frame. For example, during the first data packet communication frame 340 in an embodiment, the wireless radio system of the wireless communication dongle 330 or the information handling system 300 may receive a number (N) of data packets within an initial group of first wireless IO device data packets corresponding to the specified number of data packets defined within the initial polling packet 310 for the first wireless IO device 380. Each of the initial group of first wireless IO device data packets 341 and 342 may be transmitted to the wireless communication dongle 330 or the information handling system 300 in an embodiment at the designated initial first wireless IO device allotted data packet transmission time slots identified within the initial polling packet 310 for the first wireless IO device 380.

At block 612, the dongle wireless radio system may receive a new connection request from the second wireless IO device during the reserved provisional time slot in the extended, abbreviated time within the initial polling packet in an embodiment. For example, the second wireless IO device 390 in an embodiment may receive the initial polling packet 310 after waking from a sleep state (e.g., as described at block 504 of FIG. 5) that instructs the first wireless IO device 380 to transmit a specified number (e.g., N) of data packets (e.g., 341 and 342) at specified time slots during a first data packet communication frame 340. The second wireless IO device 380 in an embodiment may transmit a new request to connect 320 to the wireless communications dongle 330 or internal wireless radio system of the information handling system 300 upon determining that the data packets from the first wireless IO device 380 have been sent, as described in greater detail above with respect to FIG. 5 at blocks 506 and 508.

The controller of the wireless radio system may execute code instructions of the collision free wireless IO device network joining system in an embodiment at block 614 to generate and transmit to a plurality of wireless IO devices an updated polling packet acknowledging the number of packets received from the first wireless IO device during the most recent data packet communication from and instructing the first and second wireless IO devices to transmit more data packets at the identified time slots within the next communication frame. For example, the wireless communications dongle 330 or internal wireless radio system of the information handling system 300 may receive the request to connect 320 from the second wireless IO device 390 (e.g., keyboard) in the reserved provisional time slot 321, and then may respond to the request to connect 320 by transmitting a second, updated polling packet 370. This updated polling packet 370 may instructs each of the wireless IO devices (e.g., 380 and 390 operatively connected with the wireless communications dongle 330 or internal wireless radio system of the information handling system 300 that have requested to connect (e.g., both keyboard and mouse) to transmit a plurality of data packets of a specified length and at specified time slots during a second data packet communication frame between the wireless communications dongle 330 or internal wireless radio system of the information handling system 300 and each of the operatively connected wireless IO devices (e.g., including 380 and 390). In such a way, the collision free wireless IO device network joining system may orchestrate a collision-free method for a second wireless IO device to join a network in which the wireless communications dongle 330 or internal wireless radio system of the information handling system 300 is currently already transceiving data with a first wireless IO device 380. This added latency to the data packet communication frame for the reserved provisional time slot 321 is an abbreviated amount of time and relatively small additional latency of the overall data packet communication fame 340 and considering its potential high report rates and throughput. For example, the reserved provisional time slot 321 may be about 100 μs in an embodiment. It is contemplated that the reserved provisional time slot 321 may be of any duration in other embodiments. This wireless IO device communication protocol, therefore, may decrease the frequency of ACK data packets transmitted, latency, and the frequency of mode-switching described herein with respect to existing systems, improve overall user experience, and may further decrease power consumed by rapid mode-switching while allowing for on the fly mode switching to add a second wireless IO device 390.

In an embodiment, the updated polling packet 370 may also include an acknowledgement header (ACK) identifying the number (N) of packets received from the first wireless IO device (not shown) during the data packet communication frame 340. For example, in an embodiment in which the Nth packet is the fifth of five packets allotted to the wireless IO device for transmission within the data packet communication frame 340 within the initial polling packet 310, such an updated polling packet 370 may acknowledge receipt of five packets. The updated polling packet 370 in an embodiment may further include updated instructions for synchronizing transmission of data packets within a second, later data packet communication frame. For example, the updated polling packet 370 may, at the very least, provide an updated time for initiation of such a second, later data packet communication frame such as N packets for the first wireless IO device 380, a number (M) of data packets to be included from the second wireless IO device 390, as well as lengths of those packets, and data packet transmission time slots allotted to transmission of those data packets from the first and second wireless IO device 380 and 390.

In another example embodiment described with respect to FIG. 4, the wireless communications dongle 430 or internal wireless radio system of the information handling system 400 may respond to the request to connect received at block 612 by transmitting a second, updated polling packet (e.g., 403a and 403b) that instructs each of the wireless IO devices (e.g., 480 and 490) operatively connected with the wireless communications dongle 430 or internal wireless radio system of the information handling system 400 that have requested to connect (e.g., both mouse and keyboard) to transmit a plurality of data packets of a specified length and at specified time slots during a second data packet communication frame 420 between the wireless communications dongle 430 or internal wireless radio system of the information handling system 400 and each of the operatively connected wireless IO devices 480 and 490.

The controller of the wireless communications dongle 430 or the information handling system 400 executing code instructions of the collision free wireless IO device network joining system in an embodiment may determine a data packet number (e.g., N packets for the first wireless IO device 480 and M packets for the second wireless IO device 490), and data packet length, or allotted data packet transmission time slots for receipt of data packets transmitted from the first and second wireless IO devices 480 and 490. During the second data packet communication frame 420, the first wireless IO device 480 (e.g., mouse) may be instructed via the updated polling packet 403a to transmit a number (N) of data packets within an updated group of first wireless IO device data packets at updated first wireless IO device allotted data packet transmission time slots (e.g., 421 to 422). The second wireless IO device 490 (e.g., keyboard) in an embodiment may be instructed via the updated polling packet 403b to transmit a number (M) of data packets within an initial group of second wireless IO device data packets at initial second wireless IO device allotted data packet transmission time slots (e.g., 423 to 424). In an optional embodiment, the controller of the wireless communications dongle 430 or the information handling system 400 executing code instructions of the collision free wireless IO device network joining system may also add an abbreviated additional time to the data packet communication frame for the reserved provisional time slot (e.g., 425) within the second data packet communication frame 420 for transmission of new connection requests from any other wireless IO devices (e.g., wireless IO devices other than 480 or 490) when a plural wireless IO device mode is available. In other embodiments, the collision free wireless IO device network joining system may only seamlessly switch the wireless dongle between a single wireless IO device mode to a dual wireless IO device mode.

The controller of the wireless communications dongle 430 or the information handling system 400 may instruct the wireless radio system to transmit the updated polling packet 403a or 403b containing the number (N) for the updated group of first wireless IO device data packets, the updated first wireless IO devices allotted data packet transmission time slots (e.g., including the times at which the first wireless IO device transmits data packets 421 to 422), the number (M) for the initial group of second wireless IO device data packets, and the initial second wireless IO device allotted data packet transmission time slots (e.g., including the times at which the first wireless IO device transmits data packets 423 to 424). This updated polling packet (403a or 403b) in an embodiment may synchronize communication between the wireless communications dongle 430 or the information handling system 400 and the wireless IO devices 480 and 490 for the second data packet communication frame 420 beginning at a specified time and having the specified duration (e.g., 0.000833 seconds) according to embodiments herein.

At block 616, one or more wireless IO devices may communicate with the wireless communication dongle during one or more data packet communication frames, according to the instructions given within the updated polling packet transmitted at block 614. For example, at the time specified within the updated polling packet 403a or 403b in an embodiment, the data packet communication frame 420 may begin with transmission of a first packet 421 from the first wireless IO device 490 responsive to the updated polling packet 403a or 403b from the first wireless IO device 490, and receipt of that packet 421 at the wireless radio system of the wireless communication dongle 430 or information handling system 400. The first wireless IO device 490 in an embodiment may proceed to transmit a number (N) of data packets of the entire updated group of first wireless IO device data packets (e.g., including 421 to 422), according to the instructions given within the updated polling packet 403a or 403b. The second wireless IO device 480 in an embodiment may then proceed to transmit a number (M) of data packets of the initial group of second wireless IO device data packets (e.g., including 423 to 424), according to the instructions given within the updated polling packet 403a or 403b. The second data packet communication frame 420 in some optional embodiments may then extend beyond receipt of the Mth packet 424 from the second wireless IO device 490 to include a reserved provisional time slot 425 for transmission of new connection requests from any other wireless IO devices (e.g., other than 480 or 490). Thus, the wireless communication dongle may transition modes from one wireless IO device to two or more wireless IO devices in the wireless communication protocol described herein.

At block 618, the controller of the wireless communication dongle or the information handling system in an embodiment may determine whether the dongle or the information handling system has powered down. If the wireless communication dongle or the information handling system has powered down in an embodiment, there may be no need or no capability to switch the dongle wireless radio system to a RX mode for further communication with any wireless IO devices, and the method may then end. If the wireless communication dongle or the information handling system has not powered down in an embodiment, the method may return to block 614 to generate another updated polling packet orchestrating future data packet communication frames. By repeating the loop between blocks 614 and 618 in such a manner, the wireless communication dongle or wireless radio system of the information handling system may orchestrate communication with one or more wireless IO devices during consecutive data packet communication frames while reserving a portion of each of those consecutive data packet communication frames for receipt of connection requests from other wireless IO devices that will not collide or interfere with transmissions from the one or more wireless IO devices with which the wireless communication dongle has already established wireless links to allow another wireless IO device to join the dongle.

The blocks of the flow diagrams of FIGS. 5 and 6 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A collision free wireless input/output (IO) device network joining system of a wireless communication dongle at an information handling system comprising:
a controller to execute code instructions of the collision free wireless IO device network joining system to transmit with a wireless radio system an initial polling packet to instruct transmission by a first wireless IO device of a first selected number of first wireless IO device data packets at initial first wireless IO device allotted data packet transmission time slots and to allot additional time for a reserved provisional time slot in a first data packet communication frame;
the controller to switch the wireless radio system of the wireless communication dongle to receive, during the first data packet communication frame, an initial first wireless IO device transmitted selected number of data packets at the initial first wireless IO device allotted data packet transmission time slots from the first wireless IO device;
the wireless radio system to receive, during the reserved provisional time slot, a new connection request from a second wireless IO device; and
the controller to execute code instructions to transmit with the wireless radio system a second, updated polling packet with an acknowledgement of received data packets and instructing the first wireless IO device to transmit the first selected number of data packets and instruct the second wireless IO device to transmit of a second selected number of second wireless IO device data packets during second wireless IO device allotted data packet transmission time slots in a second data packet communication frame.

2. The collision free wireless input/output (IO) device network joining system of the wireless communication dongle of claim 1, wherein the first wireless IO device is a mouse.

3. The collision free wireless input/output (IO) device network joining system of the wireless communication dongle of claim 1, wherein the first wireless IO device is a keyboard.

4. The collision free wireless input/output (IO) device network joining system of the wireless communication dongle of claim 1, wherein the allotted additional time for the reserved provisional time slots occurs after the first selected number of data packets in the first data packet communication frame.

5. The collision free wireless input/output (IO) device network joining system of the wireless communication dongle of claim 1, wherein the reserved provisional time slot is less than two hundred microseconds.

6. The collision free wireless input/output (IO) device network joining system of the wireless communication dongle of claim 1 further comprising:
the controller to select the second selected number of data packets for the second wireless IO device in the second data packet communication frame based on a stored profile associated with the second wireless IO device indicating a standard data packet transmission rate for the second wireless IO device.

7. The collision free wireless input/output (IO) device network joining system of the wireless communication dongle of claim 1 further comprising:
the controller to select the second selected number of data packets for the second wireless IO device based on a requested second wireless IO device second selected number of data packets identified within the new connection request received from the second wireless IO device.

8. A method for collision free joining of a second wireless IO device to a wireless input/output (IO) device network at a wireless communication dongle of an information handling system comprising:
transmitting, via a wireless radio system for the wireless communication dongle operatively coupled to the information handling system, an initial polling packet to instruct transmission by a first wireless IO device of a first selected number of first wireless IO device data packets at initial first wireless IO device allotted data packet transmission time slots and allot additional time for a reserved provisional time slot after the first selected number of first wireless IO device data packets in a first data packet communication frame for orchestrating collision-free transmission of a new connection request;
receiving, via the wireless radio system, during a first data packet communication frame the first selected number of first wireless IO device data packets at the initial first wireless IO device allotted data packet transmission time slots from the first wireless IO device;
receiving, via the wireless radio system, during the reserved provisional time slot the new connection request from a second wireless IO device; and
transmitting, via the wireless radio system, a second, updated polling packet instructing the first wireless IO device to transmit the first selected number of first wireless IO device data packets during updated first wireless IO device allotted data packet transmission time slots and instructing the second wireless IO device to transmit a second selected number of second wireless IO device data packets during second wireless IO device allotted data packet transmission time slots of a second data packet communication frame.

9. The method of claim 8, wherein the first wireless IO device is a mouse.

10. The method of claim 8, wherein the first wireless IO device is a gaming headset.

11. The method of claim 8, wherein a second reserved provisional time slot occurs after the second data packets in the second data packet communication frame.

12. The method of claim 8, wherein the reserved provisional time slot is one hundred microseconds or less.

13. The method of claim 8 further comprising:
selecting, via a controller for the wireless communication dongle, the second selected number of second wireless IO device data packets based on a request identified within the new connection request received from the second wireless IO device.

14. The method of claim 8 further comprising:
selecting, via a controller, the updated first wireless IO device allotted data packet transmission time slots and the initial second wireless IO device allotted data packet transmission time slots based on a requested second wireless IO device number of data packet transmission slots identified within the new connection request received from the second wireless IO device and on the initial first wireless IO device allotted data packet transmission time slots.

15. A collision free wireless input/output (IO) device network joining system agent of a second wireless input/output (IO) device comprising:
a controller to execute code instructions of the collision free wireless IO device network joining system agent to receive with a wireless radio system an initial polling packet from a wireless communication dongle operatively connected to an information handling system to instruct transmission by a first wireless IO device of a first selected number of first wireless IO device data packets at initial first wireless IO device allotted data packet transmission time slots in a first data packet communication frame and to allot additional time for a reserved provisional time slot in the first data packet communication frame when the first data packet communication frame is a designated data packet communication frame having the reserved provisional timeslot on a duty cycle of a plurality of data packet communication frames;
the controller to detect, during the first data packet communication frame, transmission of the first selected number of first wireless IO device data packets at the initial first wireless IO device allotted data packet transmission time slots from the first wireless IO device;
the controller to switch the wireless radio system to a transmit mode to transmit during the reserved provisional time slot a new connection request after detection of the first selected number of first wireless IO device data packets; and
the controller to execute code instructions to receive with the wireless radio system a second, updated polling packet with an acknowledgement and instructing the first wireless IO device to transmit a first selected number of data packets from the wireless IO device and instructing the second wireless IO device to transmit a second selected number of second wireless IO device data packets during second wireless IO device allotted data packet transmission time slots in a second data packet communication frame.

16. The collision free wireless IO device network joining system agent of the second wireless IO device of claim 15, wherein the first wireless IO device is a mouse.

17. The collision free wireless IO device network joining system agent of the second wireless IO device of claim 15, wherein the second wireless IO device is a keyboard.

18. The collision free wireless IO device network joining system agent of the second wireless IO device of claim 15, wherein the reserved provisional time slot is less than two hundred microseconds.

19. The collision free wireless IO device network joining system agent of the second wireless IO device of claim 15, wherein the first selected number of data packets or the second selected number of data packets instructed for the data packet communication frame is adjustable via the polling packet.

20. The collision free wireless IO device network joining system agent of the second wireless IO device of claim 15, wherein the new connection request includes a requested second wireless IO device second selected number of data packets.
